(19) United States
(12) Patent Application Publication
(10) Pub. No.: US 2007/0101390 A1
(43) Pub. Date: May 3, 2007

(54) Method and apparatus for maintaining ONT video behavior during initial ONT deployments, ONT reboots, and loss of OLT conditions

(76) Inventors: Marc R. Bernard, Vienna, VA (US); Thomas E. Conklin, Leesburg, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/265,493

(22) Filed: Nov. 1, 2005

(51) Int. Cl. H04N 7/173

(52) U.S. Cl. 725/129; 725/127

(57) ABSTRACT

A method of ensuring continuous receipt of video services based on certain conditions in a passive optical network (PON) is provided. The method includes (i) detecting at a PON element a condition indicating a change of states in receipt of video services, (ii) starting a timing mechanism having a default value stored in the PON element, and (iii) enabling receipt of video services at the PON element for an amount of time defined by the default value. The receipt of video services may be disabled after the amount of time defined by the default value.

### BACKGROUND OF THE INVENTION

In a passive optical network (PON), a central office may communicate with a subscriber terminal using three wavelengths: (i) an analog video wavelength, (ii) a downstream communications wavelength, and (iii) an upstream wavelength. When the central office ranges the subscriber terminal, the central office provides the subscriber terminal with its actual video service mode that indicates whether receipt of video service is enabled or disabled. Oftentimes, the central office may lose communications with the subscriber terminal. When this happens, the video service mode defaults to either enabled or disabled. If the subscriber terminal defaults to the enabled video service mode, a user may connect the subscriber terminal to any optical video distribution network and receive free video service. If, on the other hand, the subscriber terminal defaults to the disabled video service mode, a field technician cannot determine whether the subscriber terminal is functional or whether other problems exist on the PON.

### SUMMARY OF THE INVENTION

A method of ensuring continuous receipt of video services based on certain conditions in a passive optical network (PON) is provided. A method according to one embodiment of the present invention includes (i) detecting at a PON element a condition indicating a change of states in receipt video services, (ii) starting a timing mechanism having a default value stored in the PON element, and (iii) enabling receipt of video services at the PON element for an amount of time defined by the default value.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an exemplary Passive Optical Network (PON) in which an optical network terminal (ONT) continues to provide video services for a limited length of time to a subscriber when an active communications link exists between a PON card and the ONT;

FIG. 2 is a block diagram of an ONT card in accordance with embodiments of the present invention;

FIG. 3 is a flow chart of an exemplary process performed by an ONT card in accordance with embodiments of the present invention; and

FIG. 4 is a flow chart of an exemplary process performed by an ONT card in accordance with embodiments of the present invention.

### DETAILED DESCRIPTION OF THE INVENTION

A description of preferred embodiments of the invention follows.

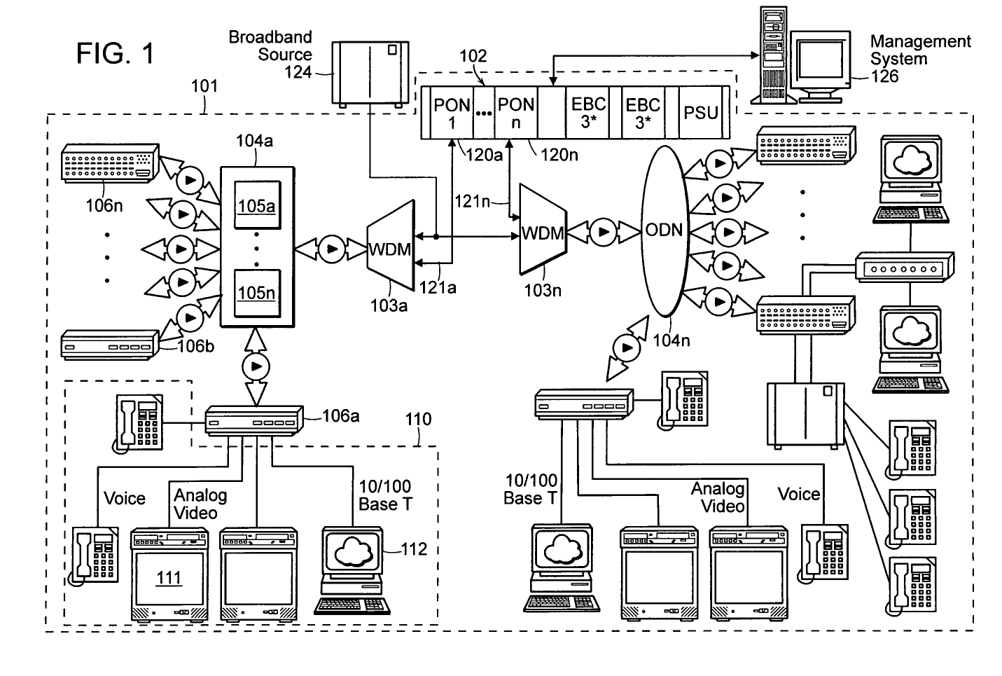

FIG. 1 is a network diagram of an exemplary passive optical network (PON) 101. The PON 101 includes an optical line terminal (OLT) 102, wavelength division multiplexers 103a, . . . , 103n, optical distribution network (ODN) devices 104a, . . . , 104n, ODN device splitters (e.g., 105a, . . . , 105n associated with ODN device 104a), optical network terminals (ONTs) (e.g., 106a, 106b, . . . , 106n corresponding to ODN device splitters 105a, . . . , 105n), and customer premises equipment (e.g., 110). The OLT 102 includes PON cards 120a, . . . , 120n, each of which provides an optical feed (121a, . . . , 121n) to ODN devices 104a, . . . , 104n. Optical feed 121a, for example, is distributed through corresponding ODN device 104a by separate ODN device splitters 105a, . . . , 105n to respective ONTs 106a, 106b, . . . , 106n in order to provide communications to and from customer premises equipment 110.

The PON 101 may be deployed for fiber-to-the-business (FTTB), fiber-to-the-curb (FTTC), and fiber-to-the-home (FTTH) applications. The optical fibers 121a, . . . , 121n in PON 101 may operate at bandwidths such as 155 Mb/sec, 622 Mb/sec, 1.25 Gb/sec, and 2.5 Gb/sec or any other desired bandwidth implementations. The PON 101 may incorporate asynchronous transfer mode (ATM) communications, broadband services such as Ethernet access and video distribution, Ethernet point-to-multipoint topologies, and native communications of data and time division multiplex (TDM) formats. Customer premises equipment (e.g., 110) that can receive and provide communications in the PON 101 may include standard telephones (PSTN and cellular), Internet Protocol telephones, Ethernet units, video devices (e.g., 111), computer terminals (e.g., 112), digital subscriber line connections, cable modems, wireless access, as well as any other conventional device.

A PON 101 includes one or more different types of ONTs (e.g., 106a, 106b, . . . , 106n). Each ONT 106a, 106b, . . . , 106n, for example, communicates with an ODN device 104a through associated ODN device splitters 105a, . . . , 105n. Each ODN device 104a, . . . , 104n in turn communicates with an associated PON card 120a, . . . , 120n through respective wavelength division multiplexers 103a, . . . , 103n. Communications between the ODN devices 104a, . . . , 104n and the OLT 102 occur over a downstream wavelength and an upstream wavelength. The downstream communications from the OLT 102 to the ODN devices 104a, . . . , 104n may be provided at 622 megabytes per second, which is shared across all ONTs connected to the ODN devices 104a, . . . , 104n. The upstream communications from the ODN devices 104a, . . . , 104n to the PON cards 120a, . . . , 120n may be provided at 155 megabytes per second, which is shared among all ONTs connected to ODN devices 104a, . . . , 104n.

A broadband source 124, of which a cable television feed through an erbium doped fiber amplifier (EDFA) is just one example, may also provide video or other broadband data to the WDMs 103a, . . . , 103n using a single wavelength (hereinafter, video wavelength). The WDMs 103a, . . . , 103n multiplex the PON upstream and downstream communications wavelengths and the video wavelength and provide the resulting multiplexed signals to respective ODN devices 104a, . . . , 104n. Each ONT (e.g., 106a, 106b, . . . , 106n) may monitor a broadband overlay signal provided by broadband source 124. One example of a broadband overlay signal is a 1550 nanometer signal used for downstream video applications.

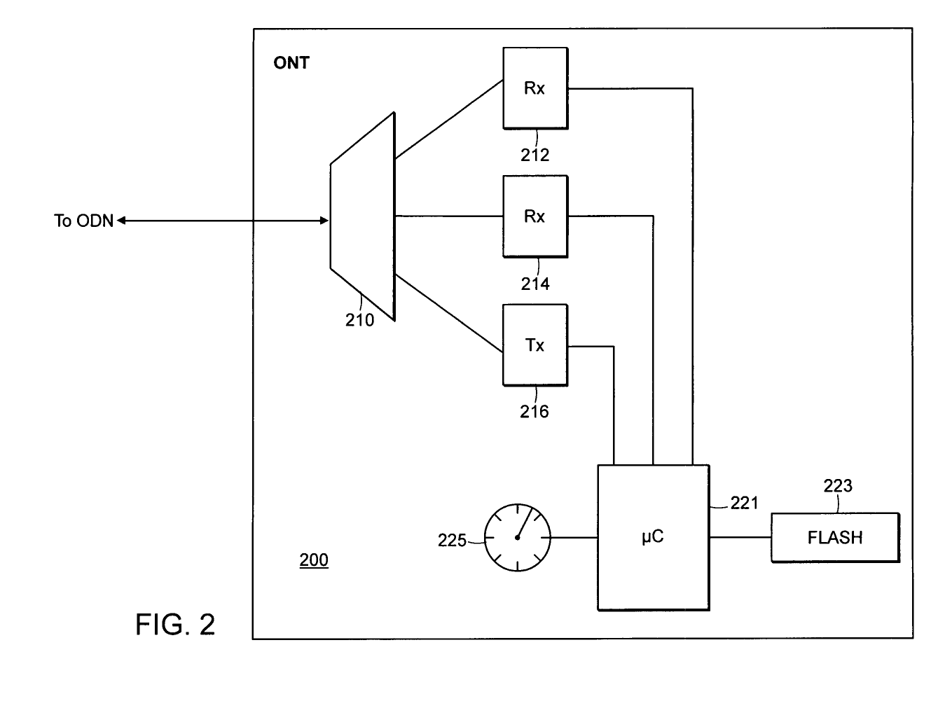

FIG. 2 is a block diagram of an ONT 200 according to an embodiment of the present invention. The ONT 200 comprises a splitter 210 which connects through a fiber to an ODN device splitter 105a of the optical network device 104a (FIG. 1). The splitter 210 may split the optical signal from the ODN device splitter into its three respective wavelengths (e.g., upstream and downstream communications wavelengths and the video or broadband data wavelength). Thus, the ONT 200 (i) receives video or broadband data 212, (ii) receives PON communications data, and (iii) transmits PON communications data 216. The ONT 200 further includes a microprocessor 221 which monitors and controls the transmission and receipt of the video and PON communications data. The microprocessor 221 is coupled to non-volatile flash memory 223 which may be used to store settings of a video service mode according to an embodiment of the present invention. The microprocessor 221 is further coupled to a timing mechanism 225, which may be used to enable video services for a given length of time.

In normal operation, a PON card of the OLT ranges an ONT to enable communications between the PON card and the ONT. Once the ONT is ranged, the PON card may provision the ONT to enable or disable video services to the ONT. In existing FTTP systems, however, the ONT may lose communications with the OLT for a variety of reasons.

First, there may be a fiber break in certain segments of the PON.

Second, the ONT may reboot, for example, in response to a command by the OLT. Reboots most often occur when the ONT is upgraded. The OLT may issue an emergency management system (EMS) command to the ONT to perform a hard reboot for troubleshooting purposes. The ONT may also reboot in response to actuating a switch on the ONT or in response to an internal command from the microprocessor.

Third, the ONT may lose communications with the OLT because there may be a problem in the OLT (e.g., a problem with a PON line card providing an OLT interface on the PON in which the ONT resides) or in the PON line cards (or other line cards that may be required to reboot or may be replaced with another line card.) When the PON line card is replaced with another line card, the communication between the ONT and the OLT is lost and an ONT loss of physical layer-loss of signal (ONT LOPL-LOS) condition occurs.

Fourth, the ONT may lose communications with the OLT because (i) there may be a bad connection between some ODN device splitters and a PON line card, which may cause high bit-error-rates; (ii) the ODN device splitter may simply lose connection with its corresponding ONT; or (iii) a misbehaving ONT (e.g., often referred to as a “rogue” ONT) may cause bad communications between all ONTs and the PON line card and thus cause all ONTs' ranging to go down.

Fifth, the ONT may lose communication with the OLT because, in some PON troubleshooting scenarios, the ONT may be commanded to perform an emergency stop (per ITU-G.983.1) (“E-STOP”) via the disable_serial_number PLOAM messages, at which point the ONT must stop regular communications with the OLT until commanded to come out of the emergency stop state.

The above list of reasons why an ONT may lose communications with a PON line card is not meant to be an exhaustive list. There are many other reasons for loss of communications between an ONT and a PON line card. For whatever reason the ONT loses ranging with the OLT, the ONT defaults to its video service enabled or disabled mode whether or not the ONT is provisioned to offer video services to its subtended subscriber.

In the case when the ONT's default attribute for video services is enabled, a user can connect such an ONT in any PON network and receive video services at no charge from the service provider. Ideally, the service provider would want to change video services whether or not an ONT has lost communications with the OLT. In the case when the ONT's default video services mode is disabled (for example, when an ONT comes out of manufacturing), a field technician cannot connect an ONT to the PON to determine if the ONT even receives video. This is a useful troubleshooting technique in the home to ensure the ONT is functional and that fiber is linked to the home. Typically, an ONT defaults to the disabled video services mode.

According to an embodiment of the present invention, a mechanism is provided that allows the ONT to continue offering video services even when the ONT loses communications with the OLT (e.g., across reboots). In one embodiment, the ONT may maintain the last known Video Services Mode in flash memory. After an OLT loses ranging with an ONT, the ONT maintains the last known video service mode for a predetermined length of time as defined by a timing mechanism. In this way, a user cannot connect an ONT in any PON network to receive free video services.

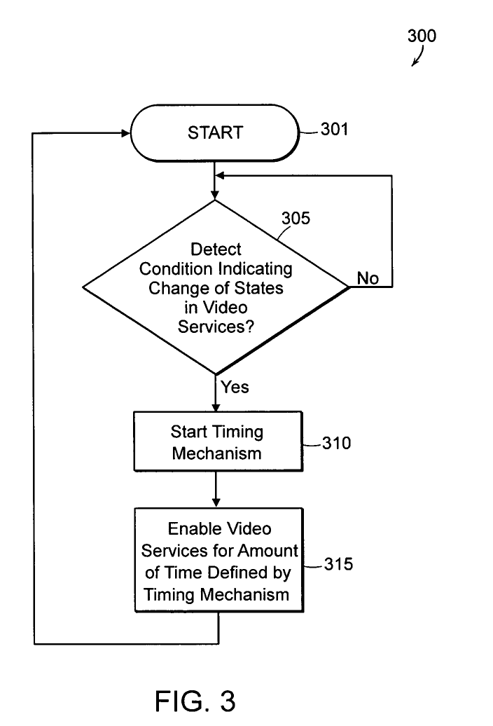

FIG. 3 is a flow chart of a process 300 performed by an ONT card in accordance with embodiments of the present invention. The process 300 starts in step 301. In decision step 305, the process 300 determines whether or not the ONT detects a condition indicating a change of states in video services. A condition indicating a change of states in video services may include any of the conditions listed above (i.e., reasons why an ONT loses communications with a PON card at the OLT). If the process 300 does not detect a condition indicating a change of state in video services, then the process 300 repeats decision step 305. If the process 300 does detect such a condition, then the process (i) starts a timing mechanism in step 310 and (ii) enables video services for an amount of time defined by the timing mechanism in step 315. When the amount of time defined by the timing mechanism expires, the process 300 may resume a video service mode stored in memory before returning to step 301 to restart the process 300. For example, if the video service mode stored in memory were set to disabled, then the process 300 would disable video services.

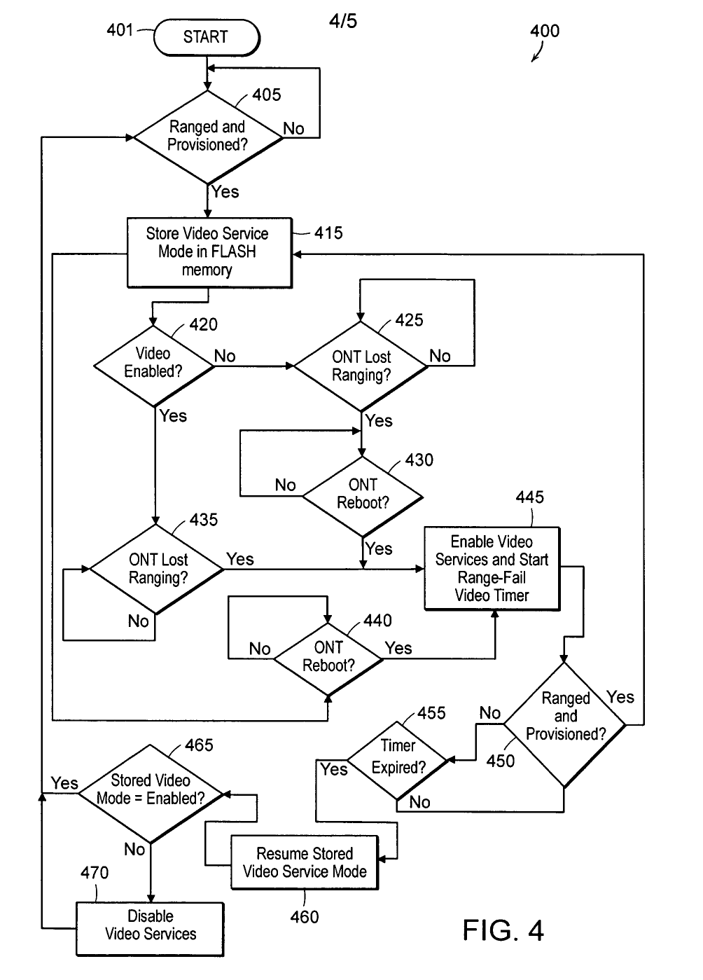

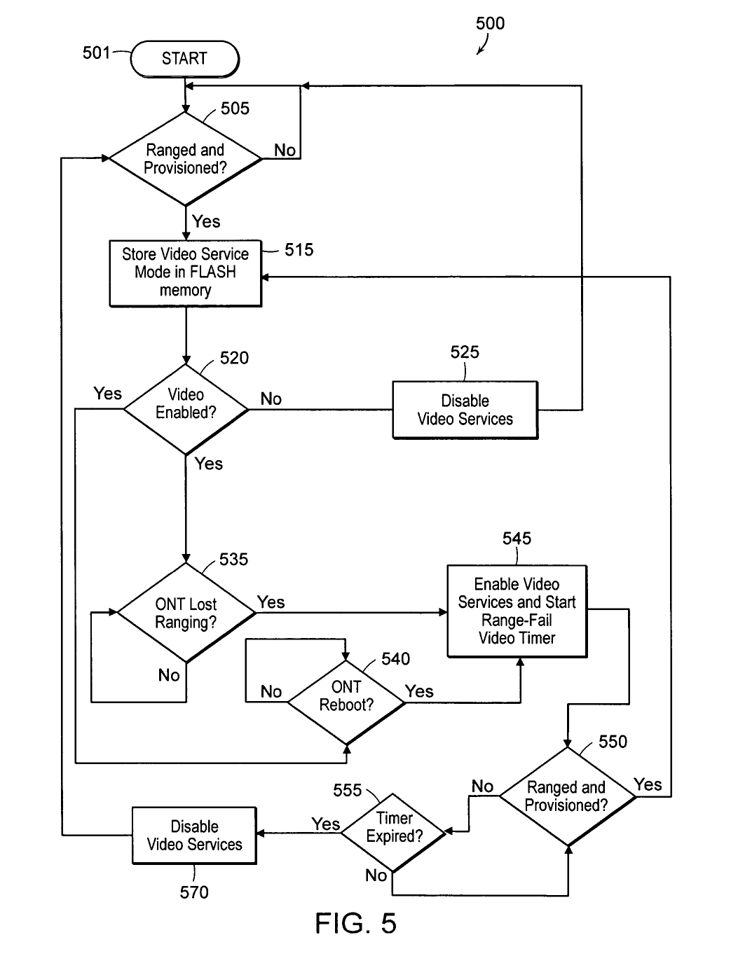

FIG. 4 is a flow chart of a process according to an embodiment of the present invention 400. The process 400 may be implemented in software, stored on a computer-readable medium (e.g., CD-ROM), and loaded and executed in the microprocessor of the ONT. In step 401, the process 400 starts. In decision step 405, the process 400 determines whether or not the ONT has been ranged and provisioned by the PON line card of the OLT. In a PON, after the PON line card ranges the ONT, it may provision the ONT to operate according to certain modes such as a video service mode. In this way, a service provider may control the services being provided to the ONT. If the ONT has not been ranged and provisioned by the PON line card, then the process 400 repeats decision step 405.

If, in decision step 405, the ONT has been ranged and provisioned, then the process 400 stores the provisioned video service mode settings in the ONT's FLASH memory in step 415. An ONT in inventory may be provisioned with a video service mode settings before being deployed, and thus, the video service mode settings would be stored in such an ONT's FLASH memory. Inventory may include new ONTs and used ONTs (e.g., refurbished ONTs ready for redeployment).

In step 420, the process 400 determines whether or not video services have been enabled. If video services have not been enabled, but instead they have been disabled, then the process 400 proceeds to step 425 to determine whether or not the ONT has lost ranging with the PON line card. If the process 400 determines that the ONT has lost ranging with the PON line card, then the process 400 determines in decision step 430 whether or not the ONT has been rebooted. If, on the other hand, the process 400 determines that the ONT has not lost ranging with the PON line card, then the process 400 repeats decision step 425.

If the ONT has lost ranging and the ONT has not been rebooted, then the process repeats decision step 430. If the ONT has lost ranging and the ONT has been rebooted, then the process 400 proceeds to step 445 in which the process 400 enables video services and starts the range-fail video timer, which is set for a default amount of time. For example, the default amount of time may be sufficient for troubleshooting purposes or may be a value that is determined by the customer. Thus, the ONT does not need to range the OLT in order to provide video services for test or troubleshooting purposes. In a preferred embodiment, the technician troubleshoots the ONT before the range-fail video timer expires.

The default timer value may be a few minutes or many hours (e.g., 1 to 72 hours). The timer value may be stored in the ONT, for example, in the FLASH memory. The timer value may also be updated, for example, locally by a technician or remotely by the Emergency Management System. The range-fail video timer may be any type of timing mechanism capable of measuring a given length of time such as a counter or a monitoring device monitoring a clock.

Referring again to decision step 420, when the process 400 determines that the video service mode has been set to enabled, the process 400 proceeds to step 435 to determine whether or not the ONT has lost ranging with the PON line card. If the ONT has indeed lost ranging with the PON line card, then the process 400 enables video services and starts the range-fail video timer. If, in decision step 435, the ONT has not lost ranging with the PON line card, then the process 400 repeats decision step 435, thereby monitoring whether or not the ONT has lost ranging with the PON line card.

Referring again to decision step 415, after the process 400 stores the provisioned video service mode settings in FLASH memory, the process 400 monitors whether or not the ONT has rebooted in step 440. In other words, when the process 400 determines in step 440 that the ONT (or the ONT microprocessor) has not been rebooted, then the process 400 repeats step 440. Once the process 400 determines that the ONT has rebooted, the process 400 proceeds to step 445 and enables video services and starts the range-fail video timer.

After the process 400 enables video services and starts the range-fail video timer, the process 400 monitors in decision step 450 whether or not the ONT has been ranged and provisioned. If the ONT has been ranged and provisioned, then the process 400 stores the provisioned video service mode settings in the ONT's flash memory in step 415. If, instead, the ONT has not been ranged and provisioned, then the process proceeds to decision step 455 and determines whether or not the range fail video timer has expired. If the range fail video timer has not expired, then the process 400 continues to monitor whether or not the ONT has been ranged and provisioned in decision step 450. However, if the timer has expired, then in step 460 the process 400 resumes the video service mode according to the video service mode settings stored in the FLASH memory. Next, in step 465, the process determines whether or not the stored video service mode settings are set to enabled. If the video service mode is set to enabled, then the process 400 returns to step 405 to determine whether or not the ONT has been ranged or provisioned. Otherwise, the process 400 disables video services in step 470 and then returns to step 405.

FIG. 4 is a flow chart of a process according to an embodiment of the present invention 400. The process 400 may be implemented in software, stored on a computer-readable medium (e.g., CD-ROM), and loaded and executed in the microprocessor of the ONT. In step 401, the process 400 starts. In decision step 405, the process 400 determines whether or not the ONT has been ranged and provisioned by the PON line card of the OLT. In a PON, after the PON line card ranges the ONT, it may provision the ONT to operate according to certain modes such as a video service mode. In this way, a service provider may control the services being provided to the ONT. If the ONT has not been ranged and provisioned by the PON line card, then the process 400 repeats decision step 405.

If, in decision step 405, the ONT has been ranged and provisioned, then the process 400 stores the provisioned video service mode settings in the ONT's FLASH memory in step 415. An ONT in inventory may be provisioned with video service mode settings before being deployed, and thus, the video service mode settings would be stored in such an ONT's FLASH memory. Inventory may include new ONTs and used ONTs (e.g., refurbished ONTs ready for redeployment).

In step 420, the process 400 determines whether or not video services have been enabled. If video services have not been enabled, but instead they have been disabled, then the process 400 proceeds to step 425 to determine whether or not the ONT has lost ranging with the PON line card. If the process 400 determines that the ONT has lost ranging with the PON line card, then the process 400 determines in decision step 430 whether or not the ONT has been rebooted. If, on the other hand, the process 400 determines that the ONT has not lost ranging with the PON line card, then the process 400 repeats decision step 425.

If the ONT has lost ranging and the ONT has not been rebooted, then the process repeats decision step 430. If the ONT has lost ranging and the ONT has been rebooted, then the process 400 proceeds to step 445 in which the process 400 enables video services and starts the range-fail video timer, which is set for a default amount of time. For example, the default amount of time may be sufficient for troubleshooting purposes or may be a value that is determined by the customer. Thus, the ONT does not need to range the OLT in order to provide video services for test or troubleshooting purposes. In a preferred embodiment, the technician troubleshoots the ONT before the range-fail video timer expires.

The default timer value may be a few minutes or many hours (e.g., 1 to 72 hours). The timer value may be stored in the ONT, for example, in the FLASH memory. The timer value may also be updated, for example, locally by a technician or remotely by the Emergency Management System. The range-fail video timer may be any type of timing mechanism capable of measuring a given length of time such as a counter or a monitoring device monitoring a clock.

Referring again to decision step 420, when the process 400 determines that the video service mode has been set to enabled, the process 400 proceeds to step 435 to determine whether or not the ONT has lost ranging with the PON line card. If the ONT has indeed lost ranging with the PON line card, then the process 400 enables video services and starts the range-fail video timer. If, in decision step 435, the ONT has not lost ranging with the PON line card, then the process 400 repeats decision step 435, thereby monitoring whether or not the ONT has lost ranging with the PON line card.

Referring again to decision step 415, after the process 400 stores the provisioned video service mode settings in FLASH memory, the process 400 monitors whether or not the ONT has rebooted in step 440. In other words, when the process 400 determines in step 440 that the ONT (or the ONT microprocessor) has not been rebooted, then the process 400 repeats step 440. Once the process 400 determines that the ONT has rebooted, the process 400 proceeds to step 445 and enables video services and starts the range-fail video timer.

After the process 400 enables video services and starts the range-fail video timer, the process 400 monitors in decision step 450 whether or not the ONT has been ranged and provisioned. If the ONT has been ranged and provisioned, then the process 400 stores the provisioned video service mode settings in the ONT's flash memory in step 415. If, instead, the ONT has not been ranged and provisioned, then the process proceeds to decision step 455 and determines whether or not the range fail video timer has expired. If the range fail video timer has not expired, then the process 400 continues to monitor whether or not the ONT has been ranged and provisioned in decision step 450. However, if the timer has expired, then in step 460 the process 400 resumes the video service mode according to the video service mode settings stored in the FLASH memory. Next, in step 465, the process determines whether or not the stored video service mode settings are set to enabled. If the video service mode is set to enabled, then the process 400 returns to step 405 to determine whether or not the ONT has been ranged or provisioned. Otherwise, the process 400 disables video services in step 470 and then returns to step 405.

FIG. 5 is a flow chart of a process according to another embodiment of the present invention 500. In step 501, the process 500 starts. In decision step 505, the process 500 determines whether or not the ONT has been ranged and provisioned by the PON line card of the OLT. If the ONT has not been ranged and provisioned by the PON line card, then the process 500 repeats decision step 505.

If, in decision step 505, the ONT has been ranged and provisioned, then the process 500 stores the provisioned video service mode settings in the ONT's FLASH memory in step 515. In step 520, the process 500 determines whether or not the video service mode has been set to enabled. If the video service mode has not been set to enabled, but instead has been set to disabled, then the process 500 proceeds to step 525 to disable video services and returns to decision step 505. Thus, the timing mechanism is disabled when the video service mode is set to disabled. If the video service mode has been set to enabled, the process 500 proceeds to step 535 to determine whether or not the ONT has lost ranging with the PON line card. If the ONT has indeed lost ranging with the PON line card, then the process 500 enables video services and starts the range-fail video timer. If, in decision step 535, the ONT has not lost ranging with the PON line card, then the process 500 repeats decision step 535, thereby monitoring whether or not the ONT has lost ranging with the PON line card.

Referring again to decision step 520, if the video service mode has been set to enabled, then the process 500 also monitors whether or not the ONT has rebooted in step 540. In other words, when the process 500 determines in step 540 that the ONT (or the ONT microprocessor) has not been rebooted, then the process 500 repeats step 540. Once the process 500 determines that the ONT has rebooted, the process 500 proceeds to step 545 and enables video services and starts the range-fail video timer.

After the process 500 enables video services and starts the range-fail video timer, the process 500 monitors in decision step 550 whether or not the ONT has been ranged and provisioned. If the ONT has been ranged and provisioned, then the process 500 stores the provisioned video service mode settings in the ONT's flash memory in step 515. If, instead, the ONT has not been ranged and provisioned, then the process proceeds to decision step 555 and determines whether or not the range fail video timer has expired. If the range fail video timer has not expired, then the process 500 continues to monitor whether or not the ONT has been ranged and provisioned in decision step 550. However, if the timer has expired, then in the process 500 disables video services in step 570 and then returns to step 505.

It should be understood that the range-fail video timer should be long enough to allow a technician to troubleshoot the ONT and ensure it is able to receive video services and detect a valid 1550 nm from the PON line card. However, the length of time monitored by the timer should not be so long as to allow the customer to steal video services for extended periods of time. The length of time monitored by timer should be short enough to make it inconvenient to watch any video programming.

While this invention has been particularly shown and described with references to preferred embodiments thereof, it will be understood by those skilled in the art that various changes in form and details may be made therein without departing from the scope of the invention encompassed by the appended claims.

Although described as “cards” herein, it should be understood that PON cards, OLT cards, or ONT cards may be systems or subsystems without departing from the principles disclosed hereinabove.

The timer may be a count-up timer, count-down timer, or any form of timer that can be used for maintaining the ONT in an enabled state for a given length of time.

Although described in reference to a passive optical network, the same or other embodiments of the present invention may be employed in an active optical network, data communications network, or any other type of network.

What is claimed is:

1. A method of ensuring continuous video services based on certain conditions in a passive optical network (PON), the method comprising:
detecting at a PON element a condition indicating a change of states in video services;
triggering a timing mechanism having a default value stored in the PON element; and
enabling receipt of video services at the PON element for an amount of time defined by the default value.

2. The method according to claim 1 wherein the default value of the timing mechanism is changed from a remote or external source.

3. The method according to claim 1 wherein the default value of the timing mechanism is stored in nonvolatile memory.

4. The method according to claim 1 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); and
a misbehaving PON element causes bad communications between PON elements.

5. The method according to claim 1 wherein the PON element enters a provisioned video service mode when the amount of time defined by the default value ends, the provisioned video service mode using information provided by another PON element.

6. The method according to claim 1 further including returning the timing mechanism to its original state in an event a loss of ranging occurs.

7. The method according to claim 1 further comprising disabling receipt of video services after the amount of time defined by the timing mechanism expires.

8. The method according to claim 1 further comprising maintaining the state of receipt of video service across PON element reboots or PON element loss of ranging.

9. A passive optical network (PON) element for ensuring continuous receipt of video services based on certain conditions in a PON comprising:
a detector that detects a condition indicating a change of states in receipt of video services; and
a timing mechanism coupled to the detector, the timing mechanism enabling receipt of video services at the PON element for a predetermined amount of time.

10. The PON element according to claim 9 further comprising nonvolatile memory coupled to the timing mechanism, the nonvolatile memory storing a value of the predetermined amount of time.

11. The PON element according to claim 10 wherein the timing mechanism enables receipt of video services at the PON element for the predetermined amount of time.

12. The PON element according to claim 10 wherein the value of the predetermined amount of time is changed from a remote or external source.

13. The PON element according to claim 9 wherein the change of states includes at least one of the following:
fiber-break in certain segments of the PON;
the PON element reboots for purposes of troubleshooting or upgrading the PON element;
the PON card or other line card reboots or is replaced with another line card;
poor connections with some Optical Distribution Network (ODN); and
a misbehaving PON element causes bad communications between PON elements.

14. The PON element according to claim 9 wherein the PON element enters a provisioned video service mode when the predetermined amount of time ends, the provisioned video service mode using information provided by another PON element.

15. The PON element according to claim 9 further including returning the timing mechanism to its original state in an event a loss of ranging occurs.

16. The PON element according to claim 9 wherein the timing mechanism disables receipt of video services at the PON element after the predetermined amount of time.

17. The PON element according to claim 9 further comprising nonvolatile memory that stores settings of a video service mode indicating whether receipt of video services is enabled or disabled.

18. The PON element according to claim 17 wherein the timing mechanism enables receipt of video services after the predetermined amount of time if the video service mode is set to enabled.

19. A method of ensuring continuous receipt of video services based on certain conditions in a passive optical network (PON), the method comprising:
storing settings of a video service mode in memory when a PON element has been ranged and provisioned;
determining whether the PON element has lost ranging and/or has been rebooted if the video service mode is set to enabled;
triggering a timing mechanism with a default value stored in the PON element;
enabling receipt of video services at the PON element; and
disabling receipt of video services at the PON element after the amount of time defined by the default value has ended.
